(19) United States
(12) Patent Application Publication
(10) Pub. No.: US 2010/0168912 A1
(43) Pub. Date: Jul. 1, 2010

(54) METHOD OF INVOKING ASYNCHRONOUS FUNCTION FOR CONTROLLING ROBOTS

(75) Inventors: Kangwoo LEE, Daejeon-city (KR); Hyoungsun KIM, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/647,832

(22) Filed: Dec. 28, 2009

(30) Foreign Application Priority Data
Dec. 29, 2008 (KR) 10-2008-0135417
Nov. 3, 2009 (KR) 10-2009-0105475

(51) Int. Cl. G06F 19/00

(52) U.S. Cl. 700/245

(57) ABSTRACT

A method of invoking an asynchronous function includes: requesting asynchronous operation performance according to the asynchronous function invoking; immediately transferring results according to the request of the asynchronous operation performance and returning a control object that can control the asynchronous operation performance of the corresponding asynchronous function; confirming the performance state of the asynchronous operation through the returned control object and confirming whether the state can be cancelled; if it is determined that the performance state of the asynchronous operation can be cancelled, confirming whether a forced cancellation request is requested; and if it is determined that the forced cancellation request is received, forcibly cancelling the asynchronous operation performance.

### RELATED APPLICATIONS

The present application claims priority to Korean Patent Application Serial Number 10-2008-0135417, filed on Dec. 29, 2008 and Korean Patent Application Serial Number 10-2009-0105475, filed on Nov. 3, 2009, the entirety of which are hereby incorporated by reference.

### BACKGROUND OF THE INVENTION

1. Field of the Invention

The present invention relates to a method of invoking asynchronous function for controlling robots. More specifically, the present invention relates to a method of invoking asynchronous function useful for mechanical apparatuses such as a robot that frequently executes operation over a long period of time.

2. Description of the Related Art

Generally, a robot includes three functional elements that senses an external environment, determines the external environment based on the sensed information, and takes action according to the determined results and includes devices that process these functions. However, since the robot has a complicated structure and requires expensive equipment, it is difficult to add various functions or a new function to the robot. Therefore, it is difficult to assign various functions to the robot and the cost is increased.

In order to provide a less expensive robot, a network robot system for performing distributed processing on the robot functions has been recently developed.

Generally, the network robot system is configured to include a server, a plurality of robot clients, and a distributed system. Network communication in the distributed system is performed through the message exchange between the distributed systems by using communication middleware The middleware is combined with an object oriented concept to provide a remote object invoking function and for the middleware, various methods such as DCOM, COBRA, RMI, XML Web Services, etc., which have already been proposed, has been used.

Meanwhile, numerous researches on invoking the asynchronous function have progressed in the existing IT fields. For example, in remote procedure call (FRC) based communication middleware such as COBRA, asynchronous method invocation (AMI) has been described.

However, most technologies or researches are closely associated with a process of processing asynchronous operation in a function invoking interface. Therefore, when most technologies or researches use other methods of invoking asynchronous function, there is a problem in that they cannot use the corresponding interface.

The ‘asynchronous function invoking’ is an invoking scheme that can process the next function invoking (or instruction) by the control immediately returned without waiting until the function is invoked and then, the result values of the function are calculated and returned, unlike the synchronous function invoking. Therefore, when the asynchronous function invoking is compared with the synchronous function invoking, there are advantages in the function and performance, such as increasing the response of the program, etc. However, methods of reliably invoking asynchronous function, such as a method of confirming the state of the asynchronously performed function invoking or the result values thereof, a method of detecting errors that occur during the asynchronous function performance, has not been specifically proposed.

In the case of the asynchronously performed function invoking, the above-mentioned functions are not provided, such that a reliable program cannot be run.

In particular, when the mechanical apparatuses such as the robot are controlled by a remote program, the method of reliably invoking the asynchronous function is urgently needed.

### SUMMARY OF THE INVENTION

The present invention proposes to solve the above problems.

It is an object of the present invention to provide a method of invoking an asynchronous function for controlling robots that can be commonly used in all programs frequently using asynchronous function invoking such as applications that control mechanical apparatuses, such as the robots, through a computer program by defining a non-dependent asynchronous function invoking interface.

A method of invoking an asynchronous function according to the present invention relates to a method for invoking an asynchronous function for controlling mechanical apparatuses. The method of invoking an asynchronous function includes: requesting asynchronous operation performance according to the asynchronous function invoking; immediately transferring results according to the request of the asynchronous operation performance and returning a control object that can control the asynchronous operation performance of the corresponding asynchronous function; confirming the performance state of the asynchronous operation through the returned control object and confirming whether the state can be cancelled; if it is determined that the performance state of the asynchronous operation can be cancelled, confirming whether a forced cancellation request is requested; and if it is determined that the forced cancellation request is received, forcibly cancelling the asynchronous operation performance.

The method of invoking an asynchronous function further includes obtaining the result values of the asynchronous operation performance through the returned control object to provide them to a caller when the forced cancellation request is not received.

The method of invoking an asynchronous function further includes determining a cause of errors that occur during the asynchronous operation performance by using the result values of the asynchronous operation performance.

The obtaining the result values of the asynchronous operation performance waits until the asynchronous operation performance ends when the asynchronous operation performance does not end and then obtains the result values of the asynchronous operation performance.

In addition, the confirming the performance state of the asynchronous operation confirms the performance state of the asynchronous operation by a polling scheme using the returned control object.

Further, the confirming the performance state of the asynchronous operation confirms at least one of whether the invoked asynchronous function starts, whether the invoked asynchronous function is successfully completed, whether the invoked asynchronous function stops due to the error occurrence during the performance, and whether the invoked asynchronous function is forcibly cancelled.

Moreover, the confirming the performance state of the asynchronous operation confirms the performance state of the asynchronous operation by a callback scheme using the returned control object.

Also, the forcibly cancelling the asynchronous operation performance receives a cancellation reason from a forced cancellation requestor, which requests the forced cancellation, as a character string to perform the cancellation processing.

The present invention has the following effects.

The asynchronous function invoking interface according to the present invention describes various asynchronous function invoking interfaces regardless of the method of processing asynchronous operation.

In addition, the method proposed in the present invention can be commonly used in all programs using the asynchronous function invoking. Therefore, in the application programs frequently using the asynchronous function invoking such as the applications that controls the mechanical apparatuses such as the robots through the computer program, convenience in the work of the developer can be further promoted.

### BRIEF DESCRIPTION OF THE DRAWINGS

FIG. 1 is a diagram showing state transition having invoked asynchronous functions;

FIG. 2 is a diagram for explaining the architecture of an asynchronous operation layer of a system for invoking an asynchronous function according to the present invention;

FIG. 3 shows an interface of an object that controls the asynchronous function invoking implemented using Java language;

FIG. 4 is a flow chart for explaining a method of invoking asynchronous function for controlling robots according to the present invention;

FIG. 5 is a diagram showing a traveling interface for controlling robot traveling using the interface for invoking the above-mentioned asynchronous function; and

FIG. 6 is a diagram showing an example of invoking the traveling function.

### DETAILED DESCRIPTION OF THE PREFERRED EMBODIMENTS

The present invention will be described below with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the drawings may be exaggerated for explicit comprehension.

Hereinafter, a method of invoking asynchronous function according to the present invention will be described in detail.

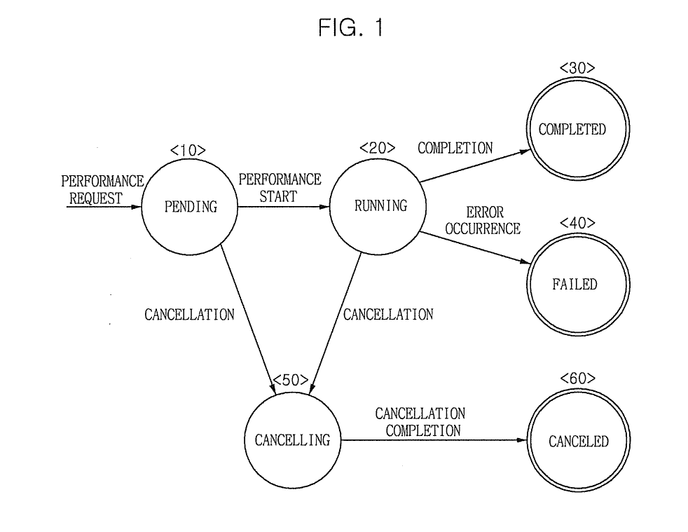

FIG. 1 is a diagram showing state transition having invoked asynchronous functions.

The invoked asynchronous function follows the state transition as shown in FIG. 1.

A ‘PENDING’ state referenced by reference numeral 10 indicates a standby state, not a start state, when the asynchronous function is invoked but there is a thread using the same resource. Of course, whether or not the asynchronous function is a standby state can be changed according to an asynchronous operation scheduler.

Next, the invoked asynchronous functions are in the ‘PENDING’ state and then, when all threads complete the use of the corresponding resource that is followed by them, the asynchronous operation performance starts and is transitioned to a ‘RUNNING’ state indicated by reference numeral 20.

When the operation performance of the invoked asynchronous function is successfully completed, it is transitioned to a ‘COMPLETED’ state as indicated by reference numeral 30. However, when the operation performance of the invoked asynchronous function is not successfully completed but ends, it is transitioned to a ‘FAILED’ state as indicated by reference numeral 40. For example, when controlling mechanical apparatuses like robots, errors frequently occur, such that the case where the operation of the invoked asynchronous function is not successfully performed and frequently ends occurs.

Generally, the function leading to the driving of the mechanical apparatuses should be relatively longer in performance time than the existing other function invoking. For example, the cases such as traveling, movement, or sentence reading of the robot require the performance time from several seconds to several minutes. In the present invention, the function invoking is defined by ‘long term performance operation’. Since the general operation is synchronously performed, it waits until the performance is completed, but it needs a function of returning the control immediately after the request in the case of long term performance operation and confirming the results if desired later. Therefore, the asynchronous function invoking should be performed. Since the asynchronous function invoking returns the control immediately after the invoking, the developer may have the case where the invoked function is forcibly cancelled if necessary. When the performance time is a long several seconds, the need of the function cancellation is additionally increased. The asynchronous function invoking can be cancelled at any time except for the case when it is completed or failed after the developer performs the invoking. In other words, when the performance state of the invoked asynchronous function is not in only a ‘COMPLETED’ state indicated by reference numeral 30 or a ‘FAILED’ state indicated by reference numeral ‘40’, the developer can cancel the operation performance of the invoked asynchronous function at any time.

Referring to FIG. 1, the cancellation can be forcibly performed in the ‘PENDING’ state indicated by reference numeral 10 and the ‘RUNNING’ state indicated by reference numeral 20. When the operation performance of the invoked asynchronous function is cancelled according to the forced cancellation request, it is immediately transitioned to a ‘CANCELLING’ state indicated by reference numeral 50. The cancellation work of the asynchronous operation performance can be changed according to the corresponding function invoking contents and the asynchronous function processing scheme.

When the cancellation work finally ends which is subjected to the ‘CANCELLING’ state indicated by reference numeral 50, it is transitioned to the ‘CANCELED’ state indicated by reference numeral 60.

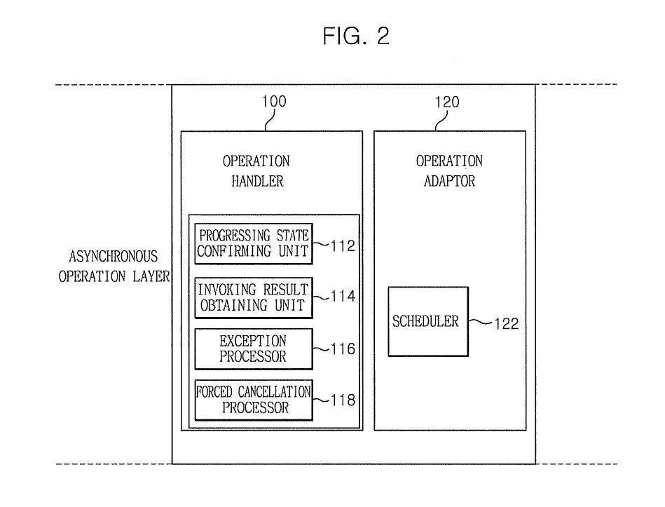

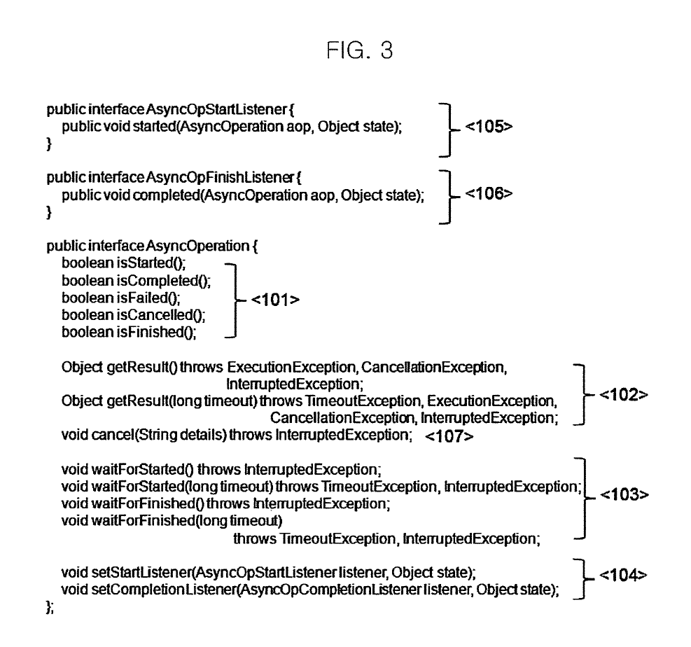

FIG. 2 is a diagram for explaining the architecture of an asynchronous operation layer of a system for invoking an asynchronous function according to the present invention. FIG. 3 shows an interface of an object that controls the asynchronous function invoking implemented using Java language.

An asynchronous operation layer in the system of invoking the asynchronous function according to the present invention is a layer that performs the asynchronous operation to be able to immediately return the control immediately after the request in the case of the operation performed for a long term such as the traveling, movement, or sentence reading and confirm the results if desired later. In the case of the asynchronous function, it is defined by an operation handle type and returns an object of the operation performed for a long term. In other words, the operation handle provides an interface that can obtain the state confirmation, control, and results of the long term asynchronous operation performance.

The asynchronous operation layer is classified into an operation handler 100, an operation adapter 120, wherein the operation adapter 120 includes a scheduler 122.

The scheduler 122 included in the operation adapter 120 assigns one work thread to the asynchronous operation request according to the asynchronous function invoking and performs the asynchronous operation object stored in a queue one by one.

The operation handler 100 plays a role of processing the asynchronous operation defined by the interface of the operation handle and requests the asynchronous operation performance to the operation adapter 120.

In more detail, the operation handler 100 includes a progress state confirming unit 112 that confirms the performance state of the invoked asynchronous function, an invoked result obtaining unit 114 that obtains the results of the invoked asynchronous function, an exception processor 116 that determines the error information generated during the performance of the invoked asynchronous performance, and a forced cancellation processor 118 that forcibly cancels the invoked asynchronous performance function.

First, since the asynchronous function is invoked and the control is then returned before the operation performance of the asynchronous function is completed and is immediately progressed to the next process, the application developer should confirm the performance state of the asynchronous function invoked by the developer. Therefore, the present invention provides the interface that can confirm the operation performance state of the asynchronous function invoked through the progress state confirming unit 112.

Reference numeral 101 of FIG. 3 shows the interface that performs an inquiry in order to confirm the performance state of the invoked asynchronous function. In other words, the interface uses inquiry methods to confirm the state operation performance of the invoked asynchronous function. Whether or not the asynchronous function actually starts can be confirmed through ‘is Started( )’ and whether or not the operation performance of the asynchronous function is successfully completed can be confirmed through ‘is Completed( )’. Whether or not the asynchronous function stops during the asynchronous function operation performance due to the error occurrence can be confirmed through ‘is Failed( )’. Whether or not the asynchronous function is forcibly cancelled during the asynchronous function operation performance can be confirmed through ‘is Canceled( )’. Finally, whether or not the operation performance of the asynchronous function ends can be confirmed through ‘is Finished( )’. The final function returns true when one of ‘is Completed( )’, ‘is Failed( )’, and ‘is Cancelled( )’ is true.

The above-mentioned interface is an interface that polls the performance state of the asynchronous function. However, confirming the state using only the polling can unnecessarily waste the resource. Therefore, the progress state confirming unit 112 according to the present invention further provides the method of confirming the state based on the callback.

Reference numeral 104 of FIG. 3 indicates an interface that sets the callback necessary to confirm the state transition of the asynchronous function. In other words, the interface is asynchronous operation performance start and end listener setting methods.

When the invoked asynchronous function actually starts, a ‘setStartListener( )’ method sets the callback to be invoked, wherein the interface of the callback to be invoked is described in reference numeral 105. When the invoked asynchronous function ends, a ‘setCompletionListener( )’ method sets the callback to be invoked, wherein the interface of the callback to be invoked is described in reference numeral 106.

As another method of confirming the state operation performance of the invoked asynchronous function, there is an interface that waits until the invoked function is transitioned to a main state.

Reference numeral 103 indicates an interface that waits until the invoked function actually starts or ends. Each of the interfaces provides two types, for example, an indefinitely waiting method and a method waiting only a predefined time.

The invoking result obtaining unit 114 provides an interface that can obtain the invoking result value of the invoked asynchronous function. Herein, since the invoking result obtaining unit 114 can obtain the result values only when the operation of the corresponding asynchronous function ends, the invoking result obtaining unit 114 waits until the asynchronous operation performance of the corresponding asynchronous performance ends in order to obtain the invoking result values of the invoked asynchronous function and then obtain the result values.

Reference numeral 102 of FIG. 3 indicates an interface to obtain the invoking result values of the invoked asynchronous function. When the operation performance does not end, each function described in reference numeral 102 waits until the operation performance ends and when the operation performance already ends, it immediately returns the result values. When the asynchronous function ends due to the occurrence of errors during the operation performance of the invoked asynchronous function, it can be confirmed by generating ‘ExecutionException’ and when the asynchronous function is forcibly canceled, it can be confirmed by generating ‘CancellationException’.

The exception processor 116 provides an interface that can determine the error information generated during the operation performance of the invoked asynchronous function. In other words, it provides the function to recognize the exception fact and the error cause that occurred during the asynchronous operation performance through the method describing the interface of the present invention, ‘ExecutionException’ exception, and ‘is Failed( )’ described in reference numeral 101.

The forced cancellation processor 118 provides an interface that can forcibly cancel the invoked asynchronous performance function. The forced cancellation processor 118 can be forcibly cancelled through the ‘cancel( )’ method as described in reference numeral 107 of FIG. 3.

The forced cancellation processor 118 can forcibly cancel the invoked asynchronous operation performance function even though it is not the caller of the asynchronous function. The forced cancellation processor 118 can receive the cancellation reason, which forcibly cancels the invoked asynchronous performance function, as a character string. In this case, when the cancellation is transferred to the caller as an exception, the forced cancellation processor 118 transfers the cancellation reason together therewith to allow the caller to determine the reason that the invoked function is cancelled.

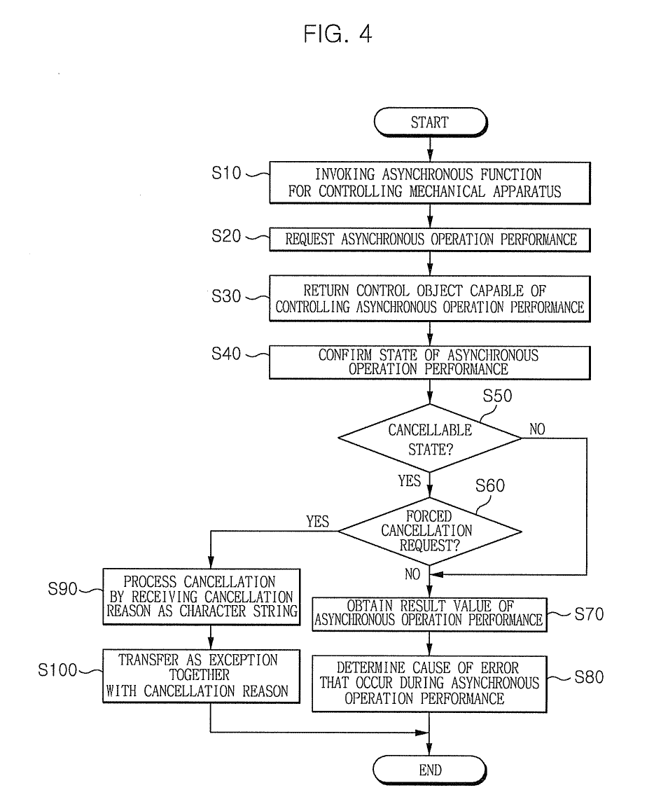

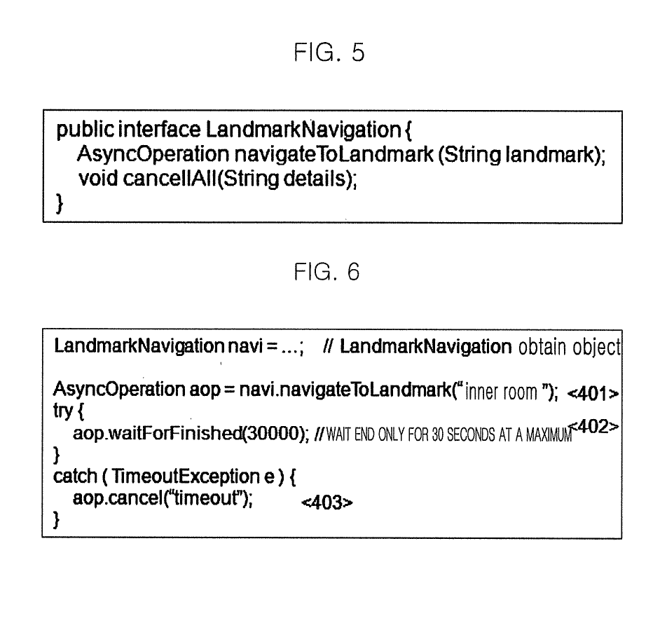

FIG. 4 is a flow chart for explaining the method of invoking the asynchronous function for controlling the robots according to the present invention and FIG. 5 is a diagram showing a traveling interface for controlling the robot traveling using the above-mentioned asynchronous function invoking interface.

First, the asynchronous function is invoked to control the mechanical apparatuses (for example, a robot) by the caller and the asynchronous operation performance is requested accordingly (S10 and S20). Unlike the existing synchronous function invoking, the invoked asynchronous function does not wait until the result values of the function are calculated and returned after the function is invoked and immediately transfers the results according to the request of the asynchronous operation performance. It returns the control object that can confirm or control the performance state of the asynchronous operation of the corresponding asynchronous function (S30). At this time, the invoked asynchronous function follows the state transition as shown in FIG. 1. In other words, when the asynchronous function is invoked but there is the thread using the same resource, the asynchronous operation according to the asynchronous function invoking is not performed but is in the standby state. Whether or not the function waits can be changed according to the scheduler. The invoked function is assigned with the corresponding resource and is transitioned to the performance state of the actual asynchronous operation when all the threads, which is followed by the function, complete the use of the corresponding resources. However, when the mechanical apparatuses such as the robots are controlled, since the errors frequently occur in the state of performing the operation (that is, ‘RUNNING’ state), the case where the asynchronous operation performance is not successfully completed and is transitioned to a failed state (that is, ‘FAILED’ state) frequently occurs.

Therefore, the present invention returns the control object that can control the performance state of the asynchronous operation at step S30 and confirms the performance state of the asynchronous operation according to the asynchronous function invoking through the returned control object (S40). In other words, the performance state of the asynchronous operation according to the asynchronous function invoking is confirmed through the control object. At this time, at step S40, the object of an ‘AsyncOperation’ type defined in FIG. 3 as the control object for controlling the performance state of the invoked asynchronous function can be used.

Next, as step S40, the performance state of the asynchronous operation is confirmed and as a result, it confirms whether the performance state of the asynchronous operation can be cancelled (S50).

If so, it determines whether the forced cancellation request is received (S60) and when the forced cancellation request is received, it receives the cancellation reason from the forced cancellation requestor as a character string and performs the cancellation processing (S90). It is transferred to the requestor as the exception together with the cancellation reason (S100).

Meanwhile, step S50 and step S60 may be performed in reverse order. In other words, it determines whether the forced cancellation request is received and if it so, it can determined that the performance state of the currently invoked asynchronous function can be cancelled.

At step S60, if the forced cancellation request is not received, it obtains the result values of the asynchronous operation performance of the invoked asynchronous function through the control object and provides it to the caller (S70). Herein, since the result values of the asynchronous operation performance can obtain the value only when the corresponding asynchronous operation ends, in order to obtain the result values of the asynchronous operation performance, it waits until the operation performance of the corresponding asynchronous function ends and then obtains the result values. Reference numeral 102 of FIG. 3 indicates an interface to obtain the invoking result values of the invoked asynchronous function. When the operation performance does not end, each function described in reference numeral 102 waits until the operation performance ends and when the operation performance already ends, it immediately provides the result values.

Next, it determines the cause of errors that occurs during the operation performance of the invoked asynchronous function and provides it to the caller (S80). In other words, it determines the exception fact and the error cause that occurs during the asynchronous operation performance through ‘ExecutionException’ and ‘is Failed( )’ described in FIG. 3 and provides it to the caller.

For example, FIG. 5 shows ‘navigateToLandmark( )’, which is a function of traveling the mechanical apparatuses such as the robots to a landmark. When the corresponding function is invoked, it does not wait until the actual traveling completes but asynchronously performs the travelling request and immediately converts the control to the caller. In other words, it returns the object of the ‘AsyncOperation’ type defined in FIG. 3 as the inquiry for the state confirmation of the invoked traveling function or the object for controlling it. The traveling function caller can control the corresponding travelling operation at any time through the ‘AsyncOperation’ object received after the function is invoked.

FIG. 6 is a diagram showing an example of invoking the traveling function.

In FIG. 6, it requests a robot to travel into an inner room (401). It waits until the traveling completes for 30 seconds at a maximum (402). If the traveling is not completed before 30 seconds, ‘TimeoutException’ is generated to indicate an example of forcibly canceling the requesting traveling (403).

With the present invention, the asynchronous function caller can control the corresponding asynchronous operation performance at any time through the control object returned after the function is invoked and in the application programs frequently using the asynchronous function invoking such as the applications that control the mechanical apparatuses such as the robots through the computer program, the convenience in the work of the developer can be further promoted.

Meanwhile, the asynchronous operation is variously generated in the control as well as other IT fields in the mechanical apparatuses such as a simple robot and the field of the present invention is nothing but a description in one embodiment. In addition, the Java language based asynchronous operation interface is a scheme of describing the concept of the present invention and the corresponding concept can be implemented and expanded through various programming languages.

The present invention can be implemented as a computer-readable code in a computer-readable recording medium. The computer-readable recording media includes all types of recording apparatuses in which data readable by a computer system is stored. Examples of the computer-readable recording media may include a ROM, a RAM, a CD-ROM, a magnetic tape, a floppy disk, an optical data storage, etc. In addition, the computer-readable recording media also include one implemented in the form of a carrier wave (i.e., transmission through the Internet). Further, the computer-readable recording media are distributed on systems connected over the network, and are stored and executed as the computer-readable code by a distribution method.

As described above, the exemplary embodiments have been described and illustrated in the drawings and the description. Herein, specific terms have been used, but are just used for the purpose of describing the present invention and are not used for qualifying the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method of invoking an asynchronous function for controlling robots, comprising:
requesting asynchronous operation performance according to the asynchronous function invoking;
immediately transferring results according to the request of the asynchronous operation performance and returning a control object that can control the asynchronous operation performance of the corresponding asynchronous function;
confirming the performance state of the asynchronous operation through the returned control object and confirming whether the state can be cancelled;
if it is determined that the performance state of the asynchronous operation can be cancelled, confirming whether a forced cancellation request is requested; and
if it is determined that the forced cancellation request is received, forcibly cancelling the asynchronous operation performance.

2. The method of invoking an asynchronous function according to claim 1, further comprising obtaining the result values of the asynchronous operation performance through the returned control object to provide them to a caller when the forced cancellation request is not received.

3. The method of invoking an asynchronous function according to claim 2, further comprising determining a cause of errors that occur during the asynchronous operation performance by using the result values of the asynchronous operation performance.

4. The method of invoking an asynchronous function according to claim 2, wherein the obtaining the result values of the asynchronous operation performance waits until the asynchronous operation performance ends when the asynchronous operation performance does not end and then obtains the result values of the asynchronous operation performance.

5. The method of invoking an asynchronous function according to claim 1, wherein the confirming of the performance state of the asynchronous operation confirms the performance state of the asynchronous operation by a polling scheme using the returned control object.

6. The method of invoking an asynchronous function according to claim 5, wherein the confirming of the performance state of the asynchronous operation confirms at least one of whether the invoked asynchronous function starts, whether the invoked asynchronous function is successfully completed, whether the invoked asynchronous function stops due to the error that occurs during the performance, and whether the invoked asynchronous function is forcibly cancelled.

7. The method of invoking an asynchronous function according to claim 1, wherein the confirming of the performance state of the asynchronous operation confirms the performance state of the asynchronous operation by a callback scheme using the returned control object.

8. The method of invoking an asynchronous function according to claim 1, wherein the forcibly cancelling the asynchronous operation performance receives a cancellation reason from a forced cancellation requestor, which requests the forced cancellation, as a character string to perform the cancellation processing.
